(19) United States
(12) Patent Application Publication
(10) Pub. No.: US 2019/0137991 A1
(43) Pub. Date: May 9, 2019

(54) METHOD AND SYSTEM TO RETROFIT INDUSTRIAL LIFT TRUCKS FOR AUTOMATED MATERIAL HANDLING IN SUPPLY CHAIN AND LOGISTICS OPERATIONS

(71) Applicant: STOCKED ROBOTICS, INC., College Station, TX (US)

(72) Inventor: Saurav Agarwal, College Station, TX (US)

(73) Assignee: STOCKED ROBOTICS, INC., College Station, TX (US)

(21) Appl. No.: 16/198,579

(22) Filed: Nov. 21, 2018

Related U.S. Application Data
(63) Continuation-in-part of application No. 16/183,592, filed on Nov. 7, 2018.
(60) Provisional application No. 62/582,739, filed on Nov. 7, 2017.
(60) Provisional application No. 62/589,900, filed on Nov. 22, 2017.

(51) Int. Cl. G05D 1/00; G05D 1/02; B66F 9/06

(52) U.S. Cl. CPC G05D 1/0011; G05D 1/0231; H04N 5/247; B66F 9/063; G05D 1/0088

(57) ABSTRACT

A method to retrofit industrial lift trucks for automated material handling, comprising configuring a processor to associate a plurality of sensors with a plurality of locations of a vehicle. Implementing a mapping mode of the processor to cause the plurality of sensors to generate sensor data as the vehicle is moved around a facility. Generating a map of the facility from the sensor data, and receiving an operator input to define a mission, wherein the operator input comprises one of an object pick up command and an object drop off command. Following pick-up and drop-off commands as defined in a mission to move pallets and following a human in an autonomous fashion using a combination of sensors.

### RELATED APPLICATIONS

The present application is a continuation-in-part of U.S. patent application Ser. No. 16/183,592, and claims priority to and benefit of U.S. Provisional Patent Application Nos. 62/582,739 and 62/589,900, each of which is hereby incorporated by reference for all purposes as if set forth herein in its entirety.

### TECHNICAL FIELD

The present disclosure relates generally to automated vehicles, and more specifically to a method and system to retrofit industrial lift trucks for automated material handling.

### BACKGROUND OF THE INVENTION

Automated vehicles are known, but are expensive and are usually incompatible with automated vehicles from different manufacturers.

### SUMMARY OF THE INVENTION

A method to retrofit industrial lift trucks for automated material handling is disclosed that includes configuring a processor to associate a plurality of sensors with a plurality of locations of a vehicle. A mapping mode of the processor is implemented to cause the plurality of sensors to generate sensor data as the vehicle is moved around a facility. A map of the facility is generated from the sensor data, and an operator input is received to define a mission, wherein the operator input comprises one of an object pick up command and an object drop off command.

Other systems, methods, features, and advantages of the present disclosure will be or become apparent to one with skill in the art upon examination of the following drawings and detailed description. It is intended that all such additional systems, methods, features, and advantages be included within this description, be within the scope of the present disclosure, and be protected by the accompanying claims.

### BRIEF DESCRIPTION OF THE SEVERAL VIEWS OF THE DRAWINGS

Aspects of the disclosure can be better understood with reference to the following drawings. The components in the drawings may be to scale, but emphasis is placed upon clearly illustrating the principles of the present disclosure. Moreover, in the drawings, like reference numerals designate corresponding parts throughout the several views, and in which:

FIG. 1 is a diagram of various lift truck types, in accordance with an example embodiment of the present disclosure;

FIG. 2 shows a block diagram of exemplary retrofit kit components and how they are interconnected for the purposes of sharing data;

FIG. 3 is a diagram of an example embodiment of retrofit kit components as mounted on a center rider pallet jack type lift truck;

FIG. 4 is a flow chart of an algorithm of a mapping process, in accordance with an example embodiment of the present disclosure;

FIG. 5 is a diagram of a system that uploads sensor data to a remote server to train artificial intelligence models in one exemplary embodiment;

FIG. 6 is a flow chart of an algorithm for automatic docking process for charging, in accordance with an example embodiment of the present disclosure;

FIG. 7 is a diagram of an exemplary obstacle zone detection system;

FIG. 8 is a diagram of a system for allowing a remote operator can control a lift truck via a wireless link;

FIG. 9 is a diagram of an algorithm for controlling a vehicle, in accordance with an example embodiment of the present disclosure;

FIG. 10 is a diagram of an algorithm for controlling a vehicle, in accordance with an example embodiment of the present disclosure;

FIG. 11 is a diagram of a system, in accordance with an example embodiment of the present disclosure;

FIG. 12 is a diagram of a garment, which includes one or more unique patterns on the front and one or more unique patterns on the rear;

FIG. 13 is a diagram of a flow chart of an example algorithm that can be implemented in hardware and/or software for system control and operation;

FIG. 14 is a diagram of a flow chart of an example algorithm that can be implemented in hardware and/or software for the visual training process;

FIG. 15 is a diagram of a lift truck following an order picker and maintaining a set distance from the order picker;

FIG. 16 is a diagram of a lift truck following an order picker and avoiding an obstacle on the way; and

FIG. 17 is a flow chart of an example algorithm that can be implemented in hardware and/or software for the replanning process when an obstacle is detected.

### DETAILED DESCRIPTION OF THE INVENTION

In the description that follows, like parts are marked throughout the specification and drawings with the same reference numerals. The drawing figures may be to scale and certain components can be shown in generalized or schematic form and identified by commercial designations in the interest of clarity and conciseness.

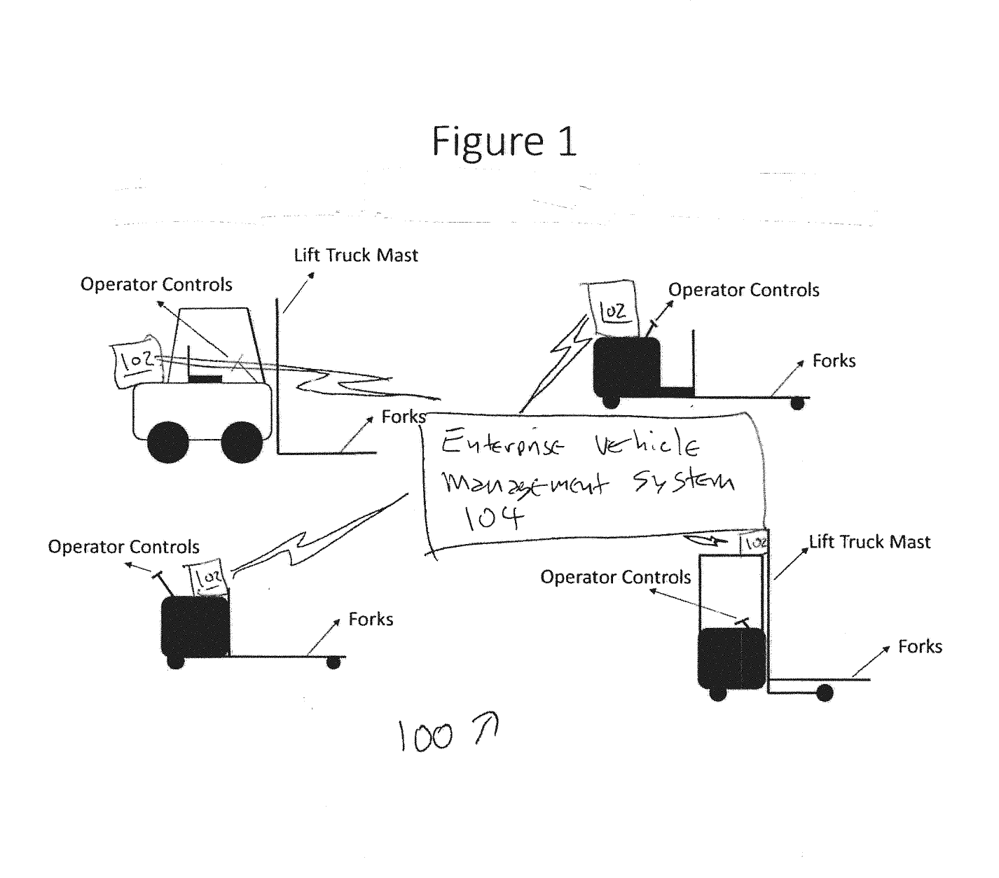

FIG. 1 is a diagram 100 of various lift truck types, in accordance with an example embodiment of the present disclosure. Material handling vehicles also known as lift trucks are used to move goods, e.g., pallets from one location to another. These vehicles are typically driven or controlled by a human operator such as a warehouse or factory employee, and in accordance with the teachings of the present disclosure can each include a retrofit controller 102 that interfaces with an enterprise vehicle management system 104. A typical use case for a lift truck is to pick up a pallet using the forks of the lift truck from the ground or from a storage rack, and then transport the pallet to another location and deposit it on the floor, to move it vertically and position it into a rack, or to perform other suitable actions. Other use cases include loading and unloading trailers, or any pallet move required as part of a material handling operation. It is quite common for such moves to be repeated throughout a work shift, either between the same two physical locations or between various combinations of physical locations. In addition, while a retrofit controller 102 is discussed in the present disclosure, the disclosed algorithmic functionality can be implemented in one or more vehicles that have suitable built in controllers, such as to coordinate the functionality of a fleet of vehicles.

In general, the algorithmic functionality described herein is provided in the form of the identification of one or more peripheral systems that are controlled by a controller or that generate data that is received by a controller, where the controller is configured by the algorithm to operate in response to controls or data. For example, various sensors and user interface devices are shown in the associated figures of the pending disclosure and discussed in the description of the figures, and associated controlled devices are also shown and discussed. The manner in which such devices generate data and are controlled is typically known, but the specific interactions between those devices, surrounding objects and terrain, and the operators are the subject of the present disclosure. These specific algorithmic interactions improve the functionality of the disclosed systems by allowing them to be used in a manner that would otherwise not be capable, such as to allow a vehicle to be remotely or automatically controlled that would otherwise not be capable of such control, to allow a fleet of vehicles in an enterprise to be centrally controlled and for other suitable purposes that provide substantially more than prior art vehicles that cannot be automatically or remotely controlled, or enterprise systems that require all vehicles to be from a single source and which do not allow for existing vehicles to be retrofitted. The ability to allow vehicles to be retrofitted alone is a substantial improvement, as it allows existing fleets of hundreds of different vehicles to be controlled without the need and expense of replacing those vehicles.

The method and system of the present disclosure includes a retrofit kit that allows lift trucks to operate autonomously without a human operator physically present on-board the vehicle. In other words, a lift truck is transformed into a driverless vehicle.

A retrofit kit in accordance with the present disclosure can include sensors, computers, communication devices, electrical circuits and mechanical actuators which allow lift trucks or other devices to operate autonomously without a human operator or via a remote tele-operator. In addition, the following aspects of the present disclosure are provided and claimed.

Sensors, processors, communication devices, electrical circuits and mechanical actuators are retrofitted to a lift truck and are configured with software that causes the processor to receive sensor information and to process the sensor information in order to drive the lift truck via electrical interfaces or through mechanical actuation.

Using a combination of processors with algorithmic structure, sensors and controllable actuators, the lift truck is adapted to generate data that is used to create a map of the physical layout of the environment, such as to generate a map of the operational environment as the lift truck is used, with additional contextual information and then use that map and contextual information to navigate autonomously. The map that is generated can be shared to other lift trucks in a fleet or to a remote server, such as via a wireless link. In addition, multiple maps can be generated by multiple lift trucks, and a centralized processor can receive the maps, identify differences and obtain additional data to resolve the difference.

The lift truck can be adapted to be operated in manual and autonomous mode via operator selection through a touch screen interface or a physical switch. In autonomous mode, missions can be defined via a web-based dashboard, a touch screen interface or in other suitable manners.

The processor of the lift truck can be configured to execute one or more algorithms that cause it to store sensor data and upload the sensor data to a remote server, to allow the sensor data to be received by a second processor that is configured to execute machine learning and artificial intelligence algorithms that allow the second processor to learn and improve autonomy capability.

The on-board sensors of retrofit controller 102 are used in conjunction with a user interface device and a processor that has been configured to generate real-time user controls for identifying proximity to obstacles and appropriate actions that can be taken by the lift truck that is using retrofit controller 102, such as to stop, reverse, turn left, turn right, or to take other actions to avoid injuries and damage. In the situations where an accident is detected by retrofit controller 102 or the associated operator, the processor of retrofit controller 102 can be configured to recognize predetermined sensor inputs (inability to move, non-linear movement over linear surfaces, increased torque, variations in torque and so forth) or to generate and detect a user control actuation for an emergency notification control, and to generate a notification message and send the notification message out via a wireless link to enterprise vehicle management system 104. Accident-related data (video, audio, machine operating parameters, operator controller entries) can then be stored in a suitable event log, such as to determine the cause of the accident and to take corrective action.

In manual mode, the onboard sensors of retrofit controller 102 are used by a processor that has been configured by one or more algorithms to receive the sensor data and to evaluate operator behavior. In one example embodiment, the algorithms can evaluate predetermined indicators of operator error, such as emergency stops, impacts with objects after operator warnings have been generated, erratic direction control, frequent extended stops that indicate operator inactivity, and so forth. The processor of retrofit controller 102 can include algorithms that alert managers of such indicators, such as at a centralized controller associated with enterprise vehicle management system 104, a handheld device user interface of the manager, text alerts, screen alerts or other suitable indications, to provide an alert to management of violations such as distracted or reckless operation.

On board systems of retrofit controller 102 such as the processor as configured with the algorithms disclosed herein operating in conjunction with sensors are configured to log positions of the associated vehicle (such as from GPS coordinates, the position of lift forks, range-bearing measurements to physical objects, vehicle direction, relative operator position and so forth), vehicle speed, vehicle diagnostic data and other suitable data in real-time and relay it to enterprise vehicle management system 104. Enterprise vehicle management system 104 can include a processor with one or more associated algorithms to allow a remote human manager receive the logged positions and associated data, such as over a wireless communications media, to schedule preventative maintenance, to monitor vehicle operator compliance with safe operation guidelines and for other suitable purposes.

The processor of retrofit controller 102 can include one or more algorithms that are used to request software updates or to receive notifications of software updates, such as from enterprise vehicle management system 104 over a wireless communications media, and to install the software updates, such as by temporarily inactivating the vehicle in response to receipt of an operator control, so that additional functional capabilities can be safely added over time without the need to take the equipment out of service at an inappropriate time or for an extended period of time.

The processor of retrofit controller 102 can include one or more algorithms that are used to detect a low fuel level, such as a battery level, and to perform corrective actions. In one example embodiment, an operator can be notified of the low battery condition and a control can be generated to allow the operator to authorize the vehicle to autonomously dock with a physical charging station until batteries are fully charged, charged sufficiently to allow completion of a current task, or in other suitable manners. Due to variations in power usage caused by operator control, a vehicle can require recharging or refueling prior to the end of a scheduled shift, or at other suitable times, such as to optimize the usage of vehicles.

The processor of retrofit controller 102 can include one or more algorithms that are used to operate the associated vehicle remotely via a wireless communications link, to provide a remote operator with the sensor data and to await control inputs from the remote operator from one or more control inputs at a physical interface, such as a computer, a head mounted display, joysticks, physical buttons, other suitable devices or a suitable combination of such device. In this manner, a remote operator can process sensor data and operate the vehicle associated with retrofit controller 102, such as to pick up pallets or other objects that are configured to be manipulated by a fork lift or other suitable manipulators, and to relocate the objects to a different location.

The processor of retrofit controller 102 can include one or more algorithms that are used to generate an alert to a remote operator and associated user controls to allow the remote operator to take control of the vehicle that retrofit controller 102 is being used with, such as to control the vehicle to perform tasks for which an associated algorithm has not been provided. The algorithms for providing the combination of alerts and operator controls allow operators to be selectively used where needed for complex or unusual tasks. In one example embodiment, enterprise vehicle management system 104 can be used to coordinate a fleet of vehicles that each have a retrofit controller 102 with a single operator or a group of operators, and the algorithm of retrofit controllers 102 can be further configured to stop operations in a safe condition if an operator is not immediately available to assist.

The processor of retrofit controller 102 can include one or more algorithms that are used to detect a physical obstruction or unexpected anomaly based on sensor input. If the algorithms of retrofit controller 102 are not able to create a safe action, they can be configured to stop operation of the vehicle, place the vehicle in a safe state and generate an alert to an operator for assistance. In one example embodiment, a single operator can be responsible for operations of two or more vehicles that are using retrofit controller 102, multiple operators can be responsible for those vehicles and a closest operator can be determined for the purpose of generating an alert, or other suitable processes can also or alternatively be used.

The sensor of retrofit controller 102 can include a bar code scanner that it is adapted to scan the item being moved and communicate that information to a warehouse or inventory management system through a direct or indirect link, such as by using a software Application Programming Interface (API).

The following exemplary components can be used to comprise a retrofit controller 102 that is mounted on-board a lift truck, in accordance with exemplary embodiments of the present disclosure, as discussed herein. These components are discussed here but are generally applicable to the various FIGURES that accompany the present disclosure:

E-Stop (emergency stop) buttons or controls can be mounted in various easy to reach places or generated on a touch screen user interface of a user device, so that the vehicle can be stopped in the event of an emergency. Unlike emergency stop buttons on conventional equipment that are located near the operator's console, the present disclosure includes emergency stop buttons external to the equipment, or remote emergency stop controls.

Imaging sensors, such as cameras or stereo camera pairs mounted in a suitable location such as a front, side, rear, top or bottom surface of a vehicle, a mast, on a manipulator device, on a fork lift mechanism, in one or more of the forward direction, side direction, rear direction, top direction, bottom direction or other suitable directions, and can be used to generate data that is algorithmically processed using known algorithms to identify objects, perceive depth and detect obstacles. An imaging sensor, such as a camera or stereo camera pair, a radar device, a light detection and ranging (LiDAR) device or other suitable devices, can be mounted in one or more of the reverse direction or other suitable directions, to perceive depth and detect obstacles.

One or more ultrasonic range finders can be mounted on the body of the vehicle and facing in a front direction, a side direction, a rear direction, an upwards direction or in other suitable locations and configured to detect obstacles in the vicinity of a vehicle that retrofit controller 102 is installed on.

The imaging sensors can include a stereo camera pair or other suitable camera sensors mounted on the front, sides, rear, top, or bottom of the vehicle body, on a mast or in other suitable locations, and can further include one or more algorithms operating on a processor that are configured to detect objects within sets of image data. A LiDAR device, laser range measurement device or other suitable devices can also generate image data, and can be mounted on the front, sides, rear, top, or bottom of the vehicle body, on a mast, a fork mechanism or in other suitable locations, and can further include one or more algorithms operating on a processor that are configured to detect objects within sets of image data and to measure a range to the objects, or other suitable data.

An Inertial Measurement Unit or other suitable devices can be rigidly mounted on the vehicle or in other suitable locations, and can be used to generate direction data. A primary computer or other suitable data processor can be provided with one or more algorithms that can be loaded onto the processor, such as in an executable file that has been compiled to allow the processor to implement the algorithms in conjunction with one or more peripheral devices such as sensor, to allow the processor to receive sensor data and generate suitable control actions in response. A secondary computer or other suitable data processor can be provided with one or more algorithms that can be loaded onto the processor, such as in an executable file that has been compiled to allow the processor to implement the algorithms in conjunction with the primary computer, sensors, actuators and the lift truck's electrical control systems or other suitable devices and systems.

Mechanical actuators or other suitable devices with digital control interfaces can be used to apply torque to the steering wheel if the steering wheel is not electrically actuated in the existing form prior to retrofit. Likewise, mechanical actuators or other suitable devices with digital control interfaces can also be used to actuate accelerators, brakes or other vehicle control devices, such as if acceleration and braking is not electrically actuated in the existing form prior to retrofit. Linear mechanical actuators or other suitable devices with digital control interfaces can be used to control hydraulic interfaces to operate forks and mast in the case that these are not electrically actuated in the existing form prior to retrofit.

Printed circuit boards can be provided that distribute power to sensors, computers and actuators and communicate data between different components of the machine. A circuit board that interfaces with an onboard CAN bus (if present) can be provided to send control signals and extract diagnostics information. Bar code scanners or other suitable devices to read bar codes, NFC tags, RFID tags or other identification tags on pallets and goods.

Weight sensors can be disposed on fork lift devices, manipulators in other suitable locations to detect a load, whether a pallet of goods has been loaded, or other suitable conditions. Ceiling facing cameras can be provided to capture structural or artificially installed feature points on the ceiling and track them in order to increase positioning accuracy. A camera can be provided for monitoring the driver's cabin to determine a driver presence or behavior.

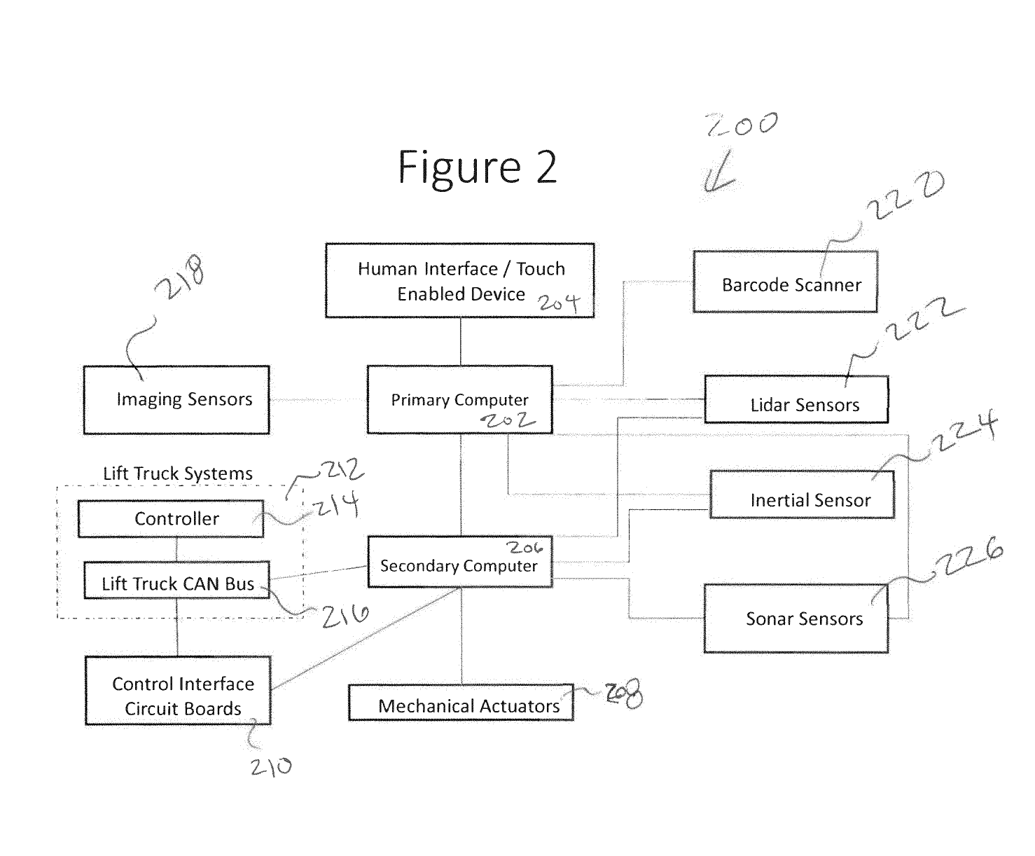

FIG. 2 shows a block diagram 200 of exemplary retrofit kit components and how they are interconnected for the purposes of sharing data. As discussed above, the retrofit kit can include one or more of a primary computer 202, a human interface such as a touch enabled device 204 (including but not limited to a touch screen interface, a capacitive interface, a tactile interface, a haptic interface or other suitable devices), a secondary computer 206, one or more mechanical actuators 208, one or more control interface circuit boards 210, a lift truck system 212 that includes a controller 214 and lift truck CAN bus 216, one or more imaging sensors 218, one or more bar code scanners, one or more LiDAR sensors 222, one or more inertial sensors 224, one or more sonar sensors 226 and other suitable devices. Each of these systems can have associated algorithmic controls that are implemented using primary computer 202, secondary computer 206, control 214 or other suitable devices, and can provide data to and receive controls and data from remote systems, such as through an enterprise vehicle management system or in other suitable manners. The components and associated algorithmic controls can be coordinated to ensure interoperability prior to installation, so as to facilitate installation in the field.

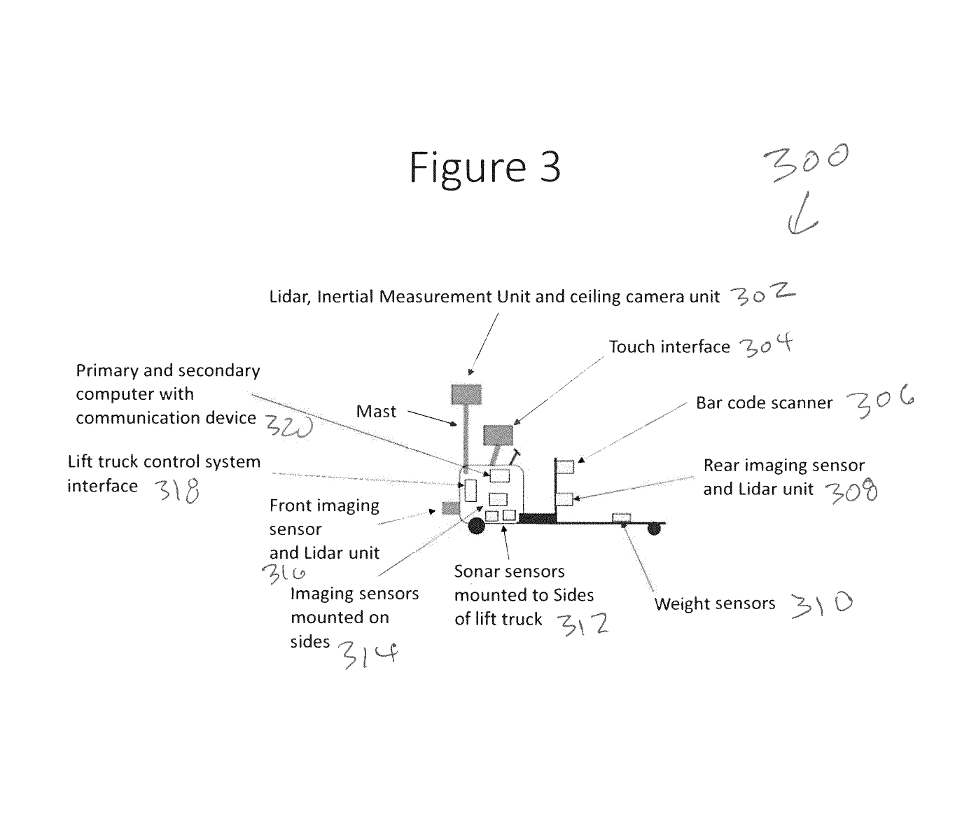

FIG. 3 is a diagram 300 of an example embodiment of retrofit kit components as mounted on a center rider pallet jack type lift truck. Diagram 300 includes LiDAR, inertial measurement unit and ceiling camera unit 302, which can be mast mounted for deployment on a lift truck. Touch interface 304 is provided for operator control, and bar code scanner 306 can be disposed at a location that will scan bar codes that are installed on a predetermined location of an object.

Rear imaging sensor and LiDAR unit 308 are used to generate image and ranging data for objects to the rear of the vehicle, and weight sensors 310 are used to determine the weight of an object that has been loaded on the lift mechanism, such as fork devices. Sonar sensors 312 and imaging sensors 314 can be disposed on the sides of the vehicle. A front imaging sensor and LiDAR unit can likewise be disposed in the front of the vehicle, and a lift truck control system interface 318 and primary and secondary computers with communication devices can be disposed internal to the vehicle.

In one exemplary embodiment, the facility mapping process can be implemented by an algorithm that includes the following steps. After a human operator switches on the vehicle, the processor executes an algorithm that generates a control on a user interface, to allow the user to select the mapping mode using a touch enabled interface. The user can then drive the vehicle around the facility where it needs to operate, to allow the vehicle sensors to gather and store sensor data. One or more algorithms implemented by the processor cause the processor to interface with the sensors on a periodic basis, to receive the sensor data and to process and store the sensor data.

Once the data gathering process is complete, the operator selects the build map mode and the vehicle processes the data on its onboard computer to formulate a map. Once the processing is complete, the data and processed map is uploaded to a remote server via a wireless link.

The algorithm can generate a map of the facility as it is being created on the user interface, to allow the human operator to review the map and to determine whether there are any errors that need to be corrected. Because errors can be generated due to sensor interference, such as obstacles or other vehicles, the errors mat require a new facility scan, a partial facility scan, a manual correction or other suitable corrections. Once the map is approved, all other retrofitted lift trucks in a fleet are adapted to download and use the map via a wireless link.

Once the map is constructed, different areas of the map can be labelled manually, such as to reflect keep-out zones where the lift truck should not operate, charger locations, pallet drop off zones, aisle numbers and so forth. These labels can allow material handling tasks to be defined as missions through user selection of appropriate pick and drop off points for each mission.

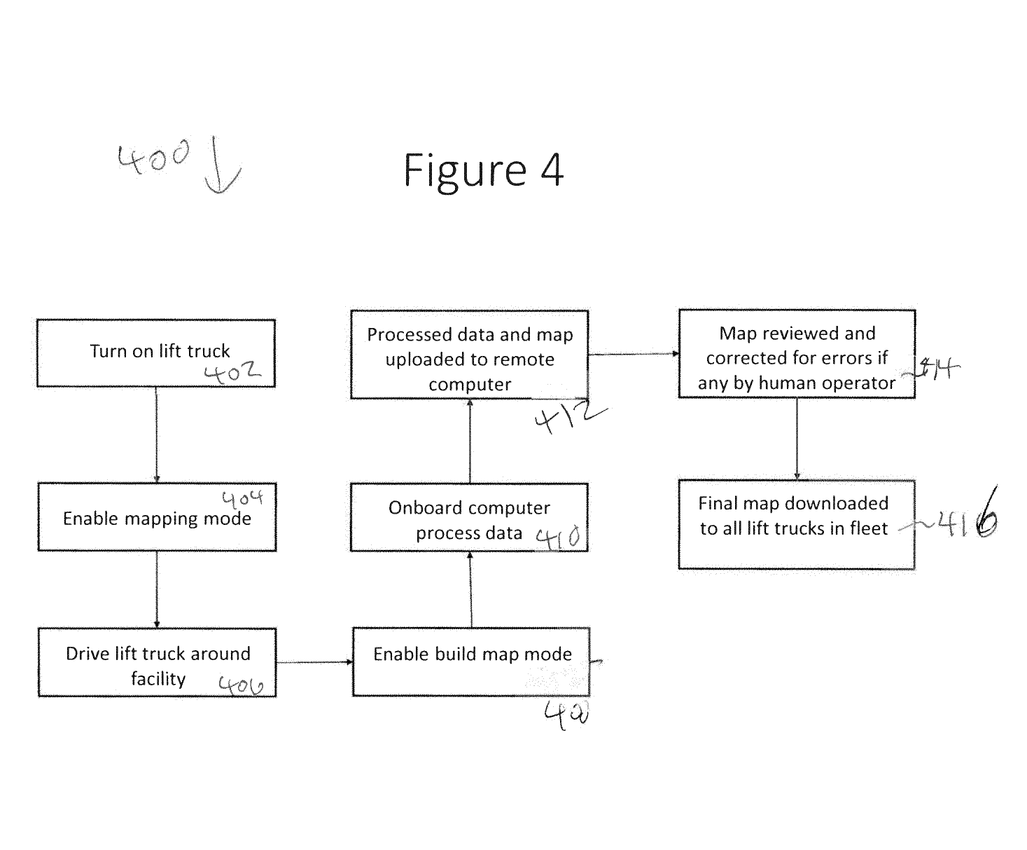

FIG. 4 is a flow chart of an algorithm 400 of a mapping process, in accordance with an example embodiment of the present disclosure. Algorithm 400 can be implemented in hardware or a suitable combination of hardware and software, and can include one or more commands operating on one or more processors. While algorithm 400 and other example algorithms disclosed herein can be shown or described in flow chart form, they can also or alternatively be implemented using state machines, object-oriented programming or in other suitable manners.

Algorithm 400 begins at 402, where a lift truck or other suitable vehicle is turned on, and controller detects the actuation of the system, such as by reading a predetermined register, receiving a data message or in other suitable manners. The algorithm then proceeds to 404, where a mapping mode is enabled. In one example embodiment, the mapping mode can configure one or more sensors to send data at a predetermined frequency or other suitable processes can be used. The algorithm then proceeds to 406.

At 406, the algorithm enables the vehicle to be driven around the facility, either automatically, by a local user, by a remote user or in other suitable manners. The algorithm then proceeds to 408 where a build map mode is enabled, such as to generate a map as a function of inertial measurements and range-bearing measurements in the front, sides and rear of the vehicle by sensors, or in other suitable manners. GPS measurements can also be used in the map generation process, if GPS signals are available. The algorithm then proceeds to 410, where one or more algorithms operating on a local computer process the data, and then to 412, where the processed data and map are transmitted to a remote computer. The algorithm then proceeds to 414.

At 414, the map is reviewed and any errors are corrected. The algorithm then proceeds to 416 where the finalized map is downloaded to all lift trucks in the fleet.

Reference [1] develops a method to compute map information from laser range scan data, which can be used to implement various aspects of the present disclosure, and which is hereby incorporated by reference as if set forth herein in its entirety.

Switching between manual and autonomous operation can be implemented using a touch enabled interface that is integrated in an easy to reach position for a human operator. A human operator can choose between manual operation and autonomous operation. A human operator can also use a physical switch to disengage software control. Multiple physical e-stop switches can also be provided, which if activated, immediately bring the vehicle to a halt and disengages software control.

In autonomous mode, algorithmic controls can be defined for the lift truck including 1) point to point navigation, 2) dropping off a pallet at a chosen destination on the map, 3) pick up of a pallet from a location defined on the map, and 4) storing, communicating and processing of Data for Learning

The sensors and integrated circuits in the retrofit kit are configured to be used with one or more algorithms operating on the processor to gather images, laser scan data, vehicle diagnostics, position and inventory information. This information can be stored and uploaded to a remote server or other suitable systems or devices. Machine learning and artificial intelligence algorithms can be trained on the captured data to improve object recognition capability. Once a new artificial intelligence model is trained, its parameters can be sent back to all lift trucks in the fleet to improve their ability to process data that defines the environment.

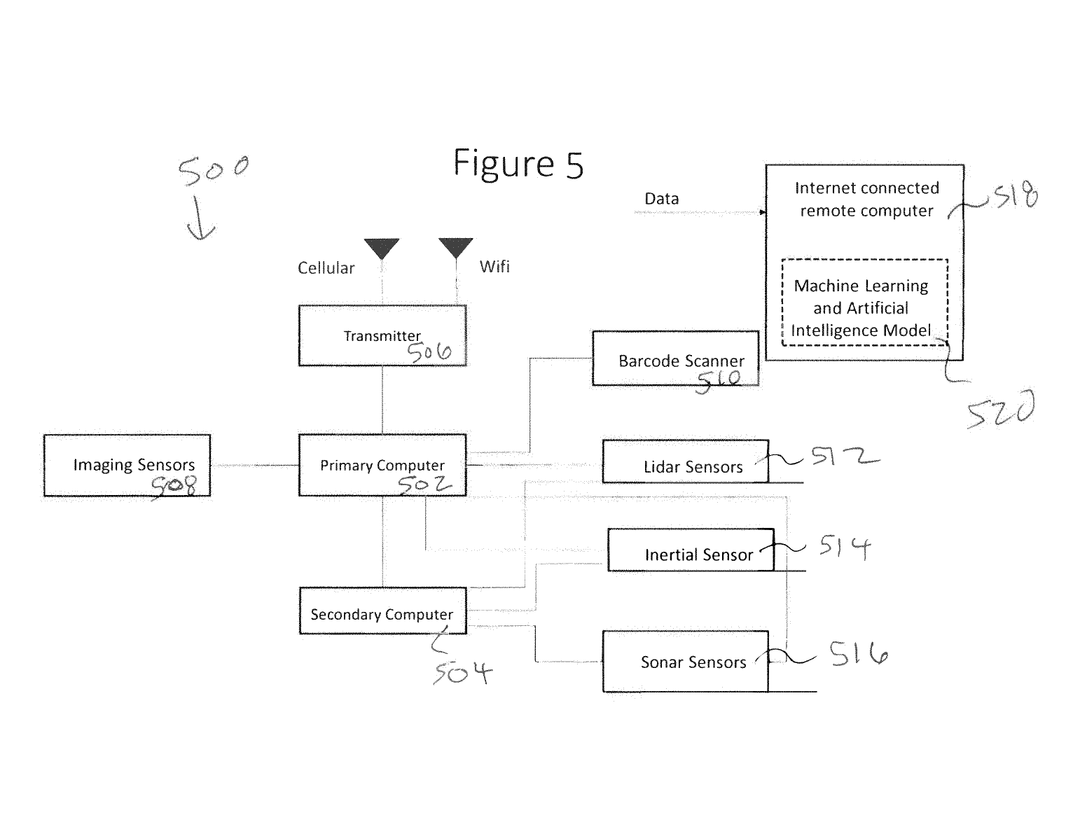

FIG. 5 is a diagram 500 of a system that uploads sensor data to a remote server to train artificial intelligence models in one exemplary embodiment. Diagram 500 includes primary computer 502, secondary computer 504, transmitter 506, imaging sensors 508, barcode scanner 510, LiDAR sensors 512, inertial sensors 514 and sonar sensors 516. An Internet connected remote computer 518 provides data to a machine learning and artificial intelligence model 520.

Camera feed, range information to obstacles and inertial measurement unit data can be processed on-board to detect and warn human operators of an impending accident. In case an accident occurs, all sensor data prior to and just after the accident can be stored on the lift truck and uploaded to a remote server via a wireless link or in other suitable locations. This configuration allows a human operator to determine the root cause of the accident.

For a lift truck in manual mode, the method of accident warning and detection works as follows: 1) an early warning distance zone can be defined around the lift truck virtually in software; 2) a danger warning distance zone can be defined around the lift truck virtually in software; 3) if an obstacle is detected via range measurements to be within the early warning zone, the operator can be alerted via audio-visual cues or in other suitable manners; 4) if an obstacle is detected within the danger zone around the lift truck through obstacle detection sensor measurements (such as sonar, cameras, Lidar etc.), the driver can be notified with repetitive visual and auditory cues and the forklift speed is limited to a maximum pre-set value or in other suitable manners; 5) if an accident is detected from the inertial sensor measurements, i.e., the rate of change of acceleration exceeds a pre-set threshold, an incident is reported to a remote server via a wireless link or in other suitable manners.

For a lift truck in autonomous mode, the method of accident warning and detection can work as follows, in one exemplary embodiment: 1) an early warning distance zone is defined around the lift truck virtually in software; 2) a danger warning distance zone is defined around the lift truck virtually in software which is smaller than the early warning danger zone; 3) if an obstacle is detected via range measurements to be within the early warning zone, the vehicle starts slowing down; 4) if an obstacle is detected to be within the danger zone then the vehicle immediately comes to a stop.

A camera pointed towards the driver's cabin captures images of driver behavior and compares that in-built safe operation behavior. If an anomaly is detected, the driver is warned with an audio-visual cue and this information is logged in a safety report and sent to a remote computer via a wireless link.

On board sensors and integrated circuits are configured to read vehicle diagnostic messages and process sensor information to compute vehicle speed and position within the facility or in other suitable locations. This information can be relayed in real-time to a remote computer where a human operator can be notified of a maintenance issue or violation of safe driving rules by a human operator, e.g., if the operator exceeds a speed or turn rate limit.

The vehicle diagnostics information is available through a CAN bus interface or other suitable interfaces. An integrated circuit is plugged into the CAN bus to read diagnostics information, or other suitable devices can also or alternatively be used. The position of the vehicle can be calculated by comparing the measurements from a range sensing device to the pre-built map. Vehicle velocity is estimated by reading speed information from the CAN bus or in other suitable manners through measurement of sensor data.

Software capabilities can be developed at a different site than where the robot operates. If a new software capability is developed that is to be sent to retrofitted lift trucks operating in the physical world, the following exemplary process or other suitable processes can be followed: 1) the software update is sent to a remote server via an internet link; 2) the remote server then contacts the primary computer mounted on lift truck through a wireless link and informs it that a software update is available; 3) the primary computer mounted on the lift truck downloads the software update and stores it in memory; 4) when the lift truck is stationary and charging, the software update is applied and the computers are automatically rebooted; 5) if an issue is detected during reboot, the secondary computer alerts nearby human operators with an audio-visual warning.

The secondary computer connects to the CAN bus interface of the lift truck, directly to the battery gauge if a CAN bus is not available, or in other suitable manners, to read the battery voltage and for other suitable purposes. If the battery voltage is detected to be lower than a pre-set threshold, the processors of the vehicle can detect that it needs to return to its charging station. If a vehicle is in the middle of a mission, the processors of the vehicle or other suitable systems or devices can estimate the energy it will take to complete the mission, and if sufficient battery energy is available to complete the mission, the lift truck can first complete the mission and return to the charging location as defined on the map. If there is insufficient power to complete the mission, the vehicle can navigates to the closest safe zone and stops, or can take other suitable actions. The vehicle processor can then alert nearby human operators with audio-visual cues or in other suitable manners to return the lift truck to charging manually. The vehicle can also alert a remote operator via a wireless link.

Before starting every mission, the on-board computer computes the battery power required to complete the mission and the battery power available. If the battery power available is less than what is required, it can reject the mission and return the lift truck to the charging station.

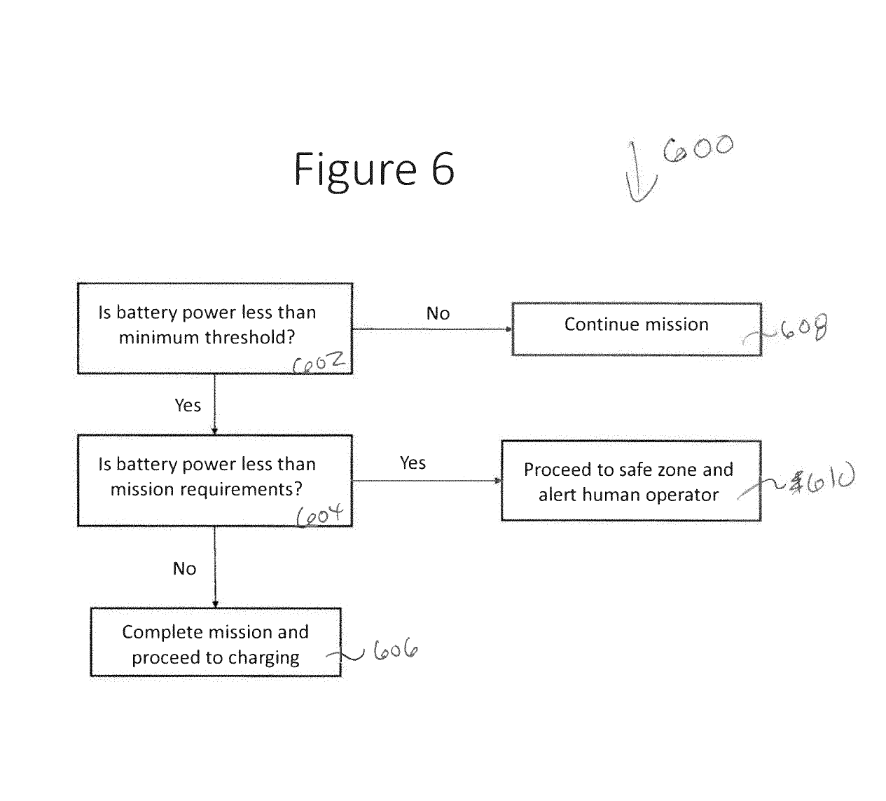

FIG. 6 is a flow chart of an algorithm 600 for automatic docking process for charging, in accordance with an example embodiment of the present disclosure. Algorithm 600 can be implemented in hardware or a suitable combination of hardware and software, and can include one or more commands operating on one or more processors. While algorithm 600 and other example algorithms disclosed herein can be shown or described in flow chart form, they can also or alternatively be implemented using state machines, object-oriented programming or in other suitable manners.

Algorithm 600 begins at 602, where it is determined whether the battery power is less than a minimum threshold. If not, the algorithm proceeds to 608, otherwise the algorithm proceeds to 604.

At 604, it is determined whether the battery power is less than needed for mission requirements. If so, the algorithm proceeds to 610 where the vehicle proceeds to a safe zone and an operator is alerted. Otherwise, the algorithm proceeds to 606 where the mission is completed and the vehicle proceeds to charging.

Camera sensors and range measurement devices such as LiDAR, sonar or other suitable devices or systems enable the on-board computer to detect obstacles in the path of vehicle. If an obstacle is detected near the vehicle, the camera feed can be used to compare the obstacle to a known database of objects. Objects can be classified in two categories; (i) safe to travel around, (ii) not safe to travel around, or other suitable categories can also or alternatively be used.

If the object is identified to be not safe to travel around, the lift truck can be commanded to stop by the computer till the path becomes clear, or other suitable instructions can be generated and implemented. If the software operating on the processor is not able to match the obstacle to a known class of objects with a high confidence (>95%) then the vehicle can be instructed to stop and to wait until the object clears the path. In other cases, the on-board computer can compute a new path to its destination and command the lift truck to follow the new path and avoid the obstacle.

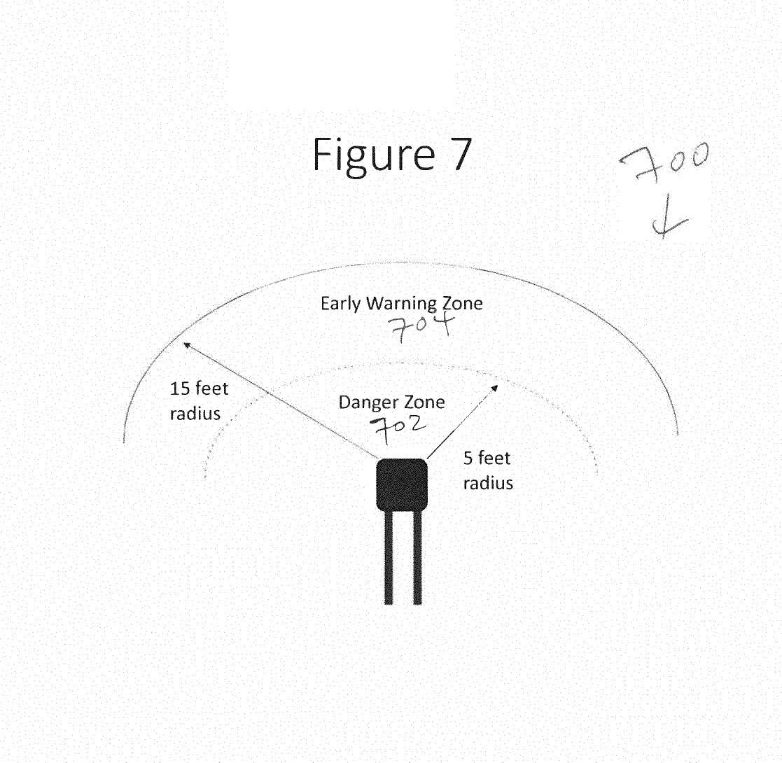

FIG. 7 is a diagram 700 of an exemplary obstacle zone detection system. Diagram 700 includes early warning zone 704, which has an associated 15 foot radius, and danger zone 702, which has an associated 5 foot radius.

The algorithms operating on the primary computer and/or the secondary computer can include learning algorithms that are configured to allow an operator to program a vehicle that has a retrofit controller 102 to perform the following tasks: 1) pick up a pallet from the ground, based on machine learning algorithms that are used to store the relevant dimensions, spacing and arrangement of pallets used in the facility; 2) drop off a pallet on the ground or onto a rack, based on machine learning algorithms that are used to store the relevant dimensions, spacing and arrangement of pallets and racks used in the facility; 3) retrieval of a pallet from a rack, based on machine learning algorithms that are used to store the relevant dimensions, spacing and arrangement of pallets and racks used in the facility; 4) load and unload trailers, based on machine learning algorithms that are used to store the relevant dimensions, spacing and arrangement of pallets and trailers used in the facility; 5) plan a new path around an unknown obstacle; and 6) other suitable repeated tasks. Such algorithmic tasks can also or alternatively be pre-programmed with operator prompts to enter relevant dimensions of pallets, racks, trailers and so forth.

If a lift truck is presented with data that defines a task that it is not pre-programmed for, such as image data that establishes that a pallet exceeds predetermined dimensions and may require restacking, the retrofit controller 102 can execute one or more algorithms that contact a processor associated with a remote operator via a wireless communications media or other suitable media. The remote processor can include one or more algorithms that generate a combined real-time sensor feed using one or more screens, a wearable head mounted device or other suitable devices to allow the remote operator to survey the environment and to use joystick controls, a touch enabled interface, a physical interface that duplicates the control system on the lift truck or other suitable control devices. In this manner, the remote operator can control the lift truck, including driving and lifting mechanisms. The operator can drive the lift truck for an entire mission, complete the complex task and hand over driving control back to the autonomous driving software, or other suitable processes can also or alternatively be performed.

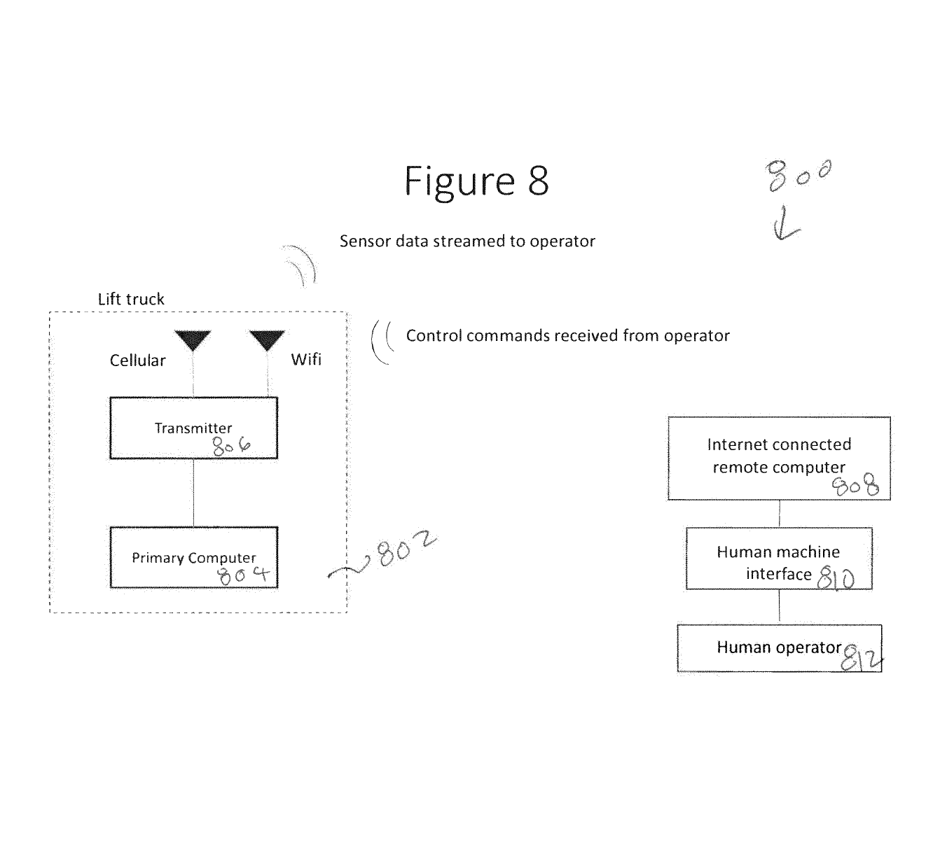

FIG. 8 is a diagram of a system 800 for allowing a remote operator can control a lift truck via a wireless link. System 800 includes lift truck 802, which further includes primary computer 804 and transmitter 806. Sensor data is streamed to an operator, and control commands are received from the operator. A remote Internet connected computer 808 includes one or more algorithms that are configured to receive the sensor data and control commands, and to generate additional control commands, such as if a local operator is not available and a remote operator needs to take over control of the vehicle. A human-machine interface 810 is used to allow human operator 812 to receive the sensor data and enter control commands.

A bar code, NFC, RFID or other suitable device scanner or other suitable device can be mounted on the mast or fork assembly or in other suitable locations such that it can scan bar code labels attached to goods that will be moved. In either manual or autonomous mode, once the lift truck starts approaching a pallet to be picked up, the on-board computer uses range sensing from LiDAR or sonar and camera based systems to detect that an item is to be picked up. When an item is being picked up, the primary computer, secondary computer or other suitable device implements one or more algorithmic controls to allow the vehicle to enter a “pick-up state.” If in manual operation mode, the algorithmic controls can generate a user interface control to allow the operator to confirm the “pick-up state” with a visual cue on a touch enabled device.

In the pick-up state, the bar code scanner can be operated by algorithmic control to make repeated scans until a bar code is detected. The weight sensor on the forks can be operated by algorithmic controls to alert the on-board computer that the pallet has been picked up. Once the pallet is picked up, the on-board computer can implement an algorithmic control to relay the bar code of the picked-up item along with the location where it was picked up to the inventory management system. If a lift truck is in autonomous mode, one or more algorithmic controls operating on an associated local or remote processor can use bar code data to decide where to drop off pallet. Once the goods are dropped off to another location, the algorithmic controls can cause the weight sensor to detect that the goods are no longer present, and to transmit the bar code data of the object that has been dropped off along with the drop location to the inventory management system, which can include one or more algorithmic controls that causes it to update its records.

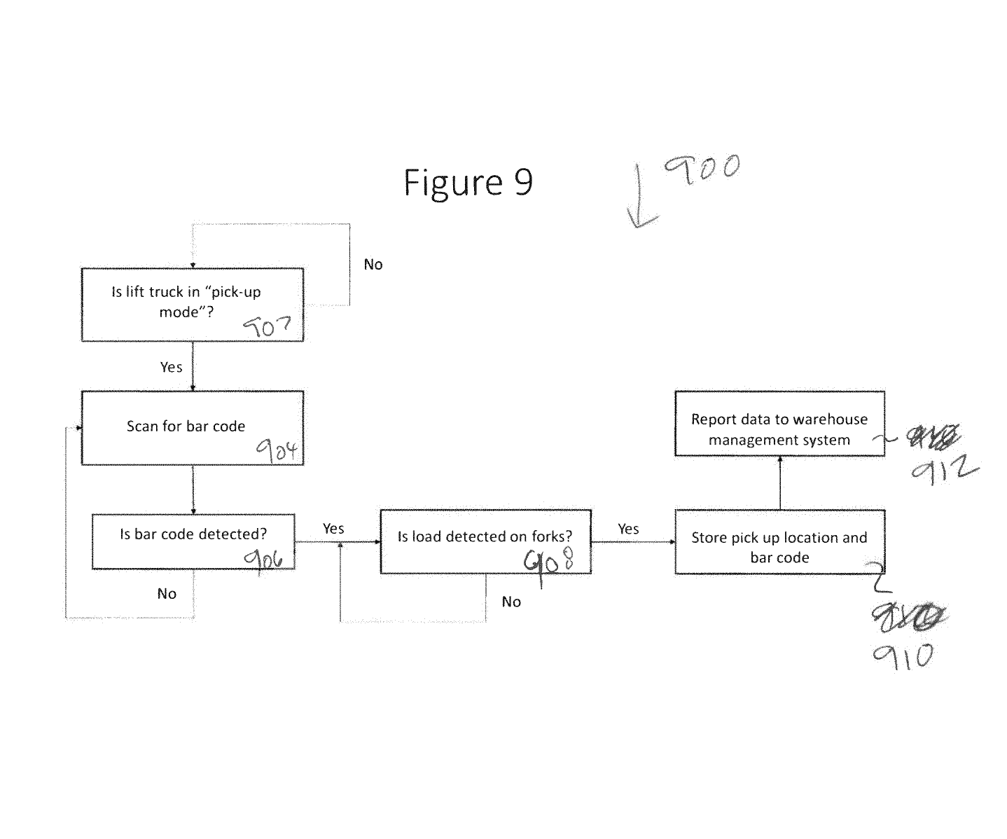

FIG. 9 is a diagram of an algorithm 900 for controlling a vehicle, in accordance with an example embodiment of the present disclosure. Algorithm 900 can be implemented in hardware or a suitable combination of hardware and software, and can include one or more commands operating on one or more processors. While algorithm 900 and other example algorithms disclosed herein can be shown or described in flow chart form, they can also or alternatively be implemented using state machines, object-oriented programming or in other suitable manners.

Algorithm 900 begins at 902, where it is determined whether a lift truck is in pick-up mode, such as by receiving a mode change command or in other suitable manners. If it is determined that the lift truck is not in pick-up mode, the algorithm returns to 902, otherwise the algorithm proceeds to 904.

At 904, a bar code scanner is operated to detect the present of a bar code. The algorithm then proceeds to 906, where it is determined whether a bar code has been detected. In one example embodiment, image data analysis algorithms can process the image data generated by the bar code scanner to determine whether a bar code is present, or other suitable techniques can also or alternatively be used. If it is determined that a bar code is not present, the algorithm returns to 904, otherwise the algorithm proceeds to 908.

At 908, it is determined whether a load has been detected on the forks. If it is determined that no load has been detected, the algorithm returns to 908, otherwise the algorithm proceeds to 910.

At 910, the pick-up location and bar code are determined and stored. The algorithm then proceeds to 912 where the pick-up location and bar code are reported to a management system processor, in addition to other suitable data.

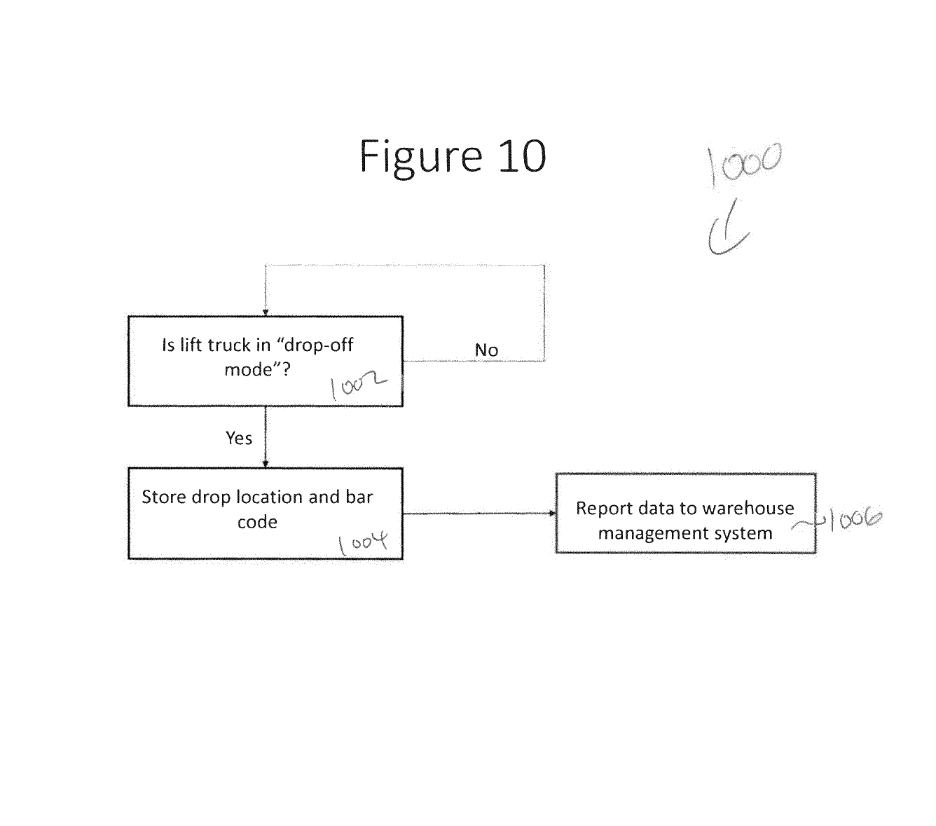

FIG. 10 is a diagram of an algorithm 1000 for controlling a vehicle, in accordance with an example embodiment of the present disclosure. Algorithm 1000 can be implemented in hardware or a suitable combination of hardware and software, and can include one or more commands operating on one or more processors. While algorithm 1000 and other example algorithms disclosed herein can be shown or described in flow chart form, they can also or alternatively be implemented using state machines, object-oriented programming or in other suitable manners.

Algorithm 1000 begins at 1002, where it is determined whether the lift truck is in drop-off mode. If it is determined that the lift truck is not in drop off mode, the algorithm returns to 1002, otherwise it proceeds to 1004 where the drop location and bar code are stored. The algorithm then proceeds to 1006 where the drop-off location and bar code are reported to a management system processor, in addition to other suitable data.

The system and method for a material handling vehicle of the present disclosure can be implemented on a vehicle that is commonly known as a lift truck or other suitable vehicles, to implement one or more algorithms that enable the vehicle to autonomously follow a human order picker under processor control, for order picking or other suitable functions (which are referred to herein generally as “order picking,” but which are not limited to order picking). The order picker can be detected, recognized and tracked by one or more algorithms that control, interface with and utilize sensors mounted on the lift truck to generate sensor data that is processed by the algorithms. The sensors mounted on the lift truck allow the lift truck to automatically detect and avoid obstacles in its path while it follows the order picker at a safe distance.

In many warehouses and distribution centers, low-level order picking is a major component of day-to-day operations. In this process, a human order picker drives or rides a lift truck across a warehouse facility to pick up items required for a particular order and place said items on a pallet loaded on to the lift truck. This is a repetitive process in which the order picker typically has to jump on and off the truck multiple times to pick up goods and then drive to the next goods pick location. Many times, order pickers walk along-side the lift truck and use the lift truck controls the advance the vehicle to the next pick location while walking along side it.

Significant labor time is expended in reaching for the vehicle controls, climbing on board the vehicle and de-boarding it during the order pick process. This time waste adversely affects the productivity of warehouse operations. The present disclosure improves order picker throughput by eliminating time spent by a human operator to advance the vehicle to the next pick location. The present disclosure also enables a lift truck operating under control of the disclosed algorithms to detect, recognize and follow a human order picker autonomously in a low level order picking operation.

The present disclosure includes a hand held or wearable device that is coupled with a voice activated system that a human operator, such as an order picker, can use to pair with a control system on the lift truck and to give motion commands to the control system. The algorithmic controls can use voice activation, physical inputs to the wearable device or other suitable inputs, and the control system can be algorithmically configured to cause the lift truck to follow the operator in a leader-follower manner by responding to the motion commands.

A computer vision software enabled system is installed in the lift truck and configured to interoperate with the controller of the lift truck. The computer vision software enabled system is configured to learn the appearance of a human order picker that is in possession of the hand held or wearable device, and is further configured to allow the controller of the lift truck to track the operator's location with respect to the lift truck. A wearable garment can also or alternatively be utilized, such as a shirt or jacket with recognizable visual markers on it that may be worn by order pickers that makes a human operator easily and uniquely identifiable and trackable by the computer vision software enabled system of the lift truck. A motion control system of the controller of the lift truck operates under control of one or more algorithms that are configured to use the relative position of the order picker with respect to the lift truck to follow the order picker.

The order picking control algorithm starts when a warehouse operation and control system receives order data for a set of goods, such as goods that need be shipped out from the warehouse. Once the order is received, a human order picker may need to visit multiple locations in the warehouse to pick up the required items and place them on a lift truck (e.g., pallet jack, fork lift etc.). During this picking process, the order picker has to rapidly and repetitively bend to pick up items and then walk to the lift truck and place the items. Once the items are placed on the lift truck, the lift truck advances to the next pick location, such as by using algorithmic or manual controls. This process is repeated until all of the items in the order have either been located or otherwise accounted for (such as by receiving an out of stock status). Once all the required items have been obtained, the full order can be taken to a designated location in the warehouse for packaging and shipping.

The disclosed retrofit kit can include one or more sensors, computers, communication devices, electrical circuits and mechanical actuators which allows lift trucks to operate autonomously without a human operator or via a remote tele-operator. In addition, the retrofit kit can include a wristband or wearable device worn by a human order picker and enabled by Bluetooth LE or any such short range wireless communication system. A Bluetooth LE transceiver can be included on the lift truck, that is configured to communicate with the lift truck software control system. A wearable garment with identifiable visual patterns on it can also or alternatively be used.

In one example embodiment, a method can be algorithmically implemented on a processor that includes 1) pairing the order picker's wearable device to the lift truck. 2) Training the lift truck to recognize the appearance of the order picker. 3) Carrying out the order picking task. Other suitable steps are readily apparent to a person of skill upon reading this disclosure.

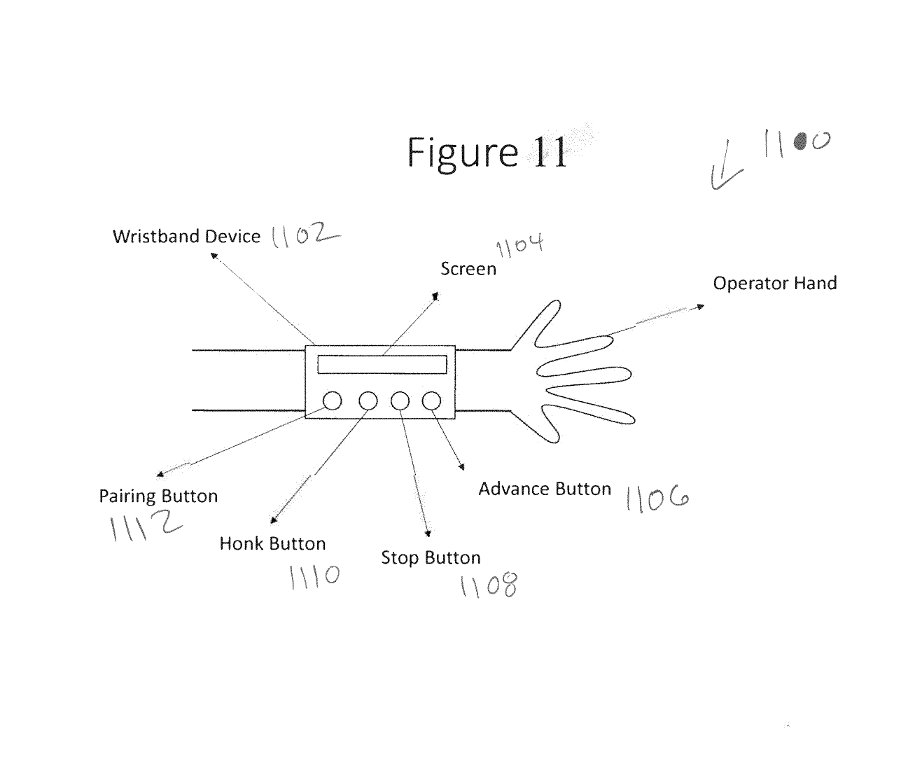

FIG. 11 is a diagram of a system 1100, in accordance with an example embodiment of the present disclosure. System 1100 includes wristband device 1102, screen 1104, advance button 1106, stop button 1108, honk button 1110 and pairing button 1112. The wristband device is pre-coded with a unique ID and is enabled with short range wireless communications an example of which is Bluetooth LE.

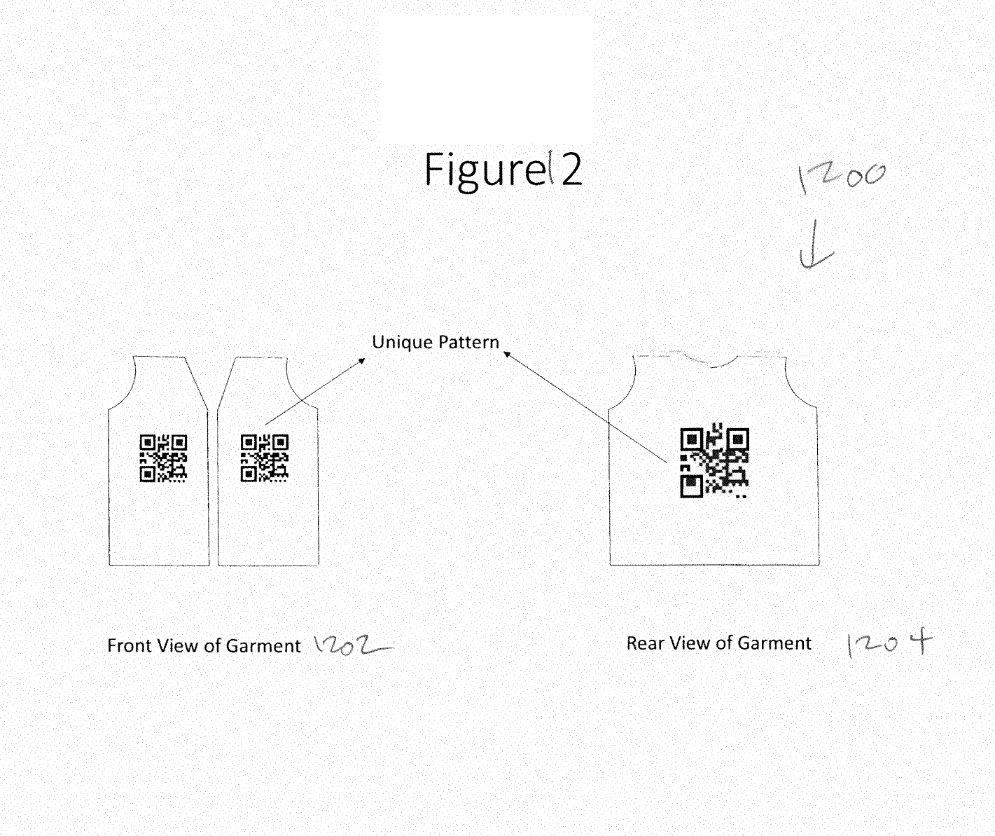

FIG. 12 is a diagram of a garment 1200, which includes one or more unique patterns 1202 on the front and one or more unique patterns 1204 on the rear.

The human order picker approaches a stationary lift truck and presses a pairing button on the lift truck to pair it with the hand held device. The pairing button is operably coupled to a controller and causes the controller to enter a state wherein it will receive inputs to allow it to operably interact with an optical recognition system or other suitable systems to identify the operator and to allow the controller to respond to controls received from the operator.

The operator presses the pairing button on his wristband device, which is configured to send a predetermined control signal to the controller to configure the controller to recognize the operator.

The lift truck scans using its wireless radio (e.g., Bluetooth LE) to scan its vicinity and detects all available wristband control devices in pairing mode. It prompts the operator to input the unique ID of the wristband device on the lift truck interface.

The lift truck pairs with the wristband device. Once the wearable device is paired, the order picker proceeds to train the lift truck to recognize himself or herself visually.

Training the computer vision software enabled system and controller of the lift truck to recognize the order picker visually allows the controller of the lift truck to uniquely identify and follow an order picker inside a warehouse or other type of facility.

Once the above pairing process is complete, the lift truck controller user interface instructs the operator to stand in front of the lift truck. The lift truck controller uses the imaging sensors and the computer vision software enabled system to obtain image data and detect unique identifying information from the image data of the order picker's visual appearance.

Once the controller of the lift truck identifies the recognizable visual patterns of the order picker's appearance from the image data, in conjunction with the computer vision software enabled system, it stores the pattern identification by creating a computer model in memory and creates an audio-visual cue to alert the operator.

The controller of the lift truck can also or alternatively send haptic feedback or other suitable user interface outputs to the wristband or other user interface device, which alerts the operator that the lift truck is paired. Z. Kalal, K. Mikolajczyk, and J. Matas, “Tracking-Learning-Detection,” Pattern Analysis and Machine Intelligence 2011 and S. Garrido-Jurado, R. Muñoz-Salinas, F. J. Madrid-Cuevas, M. J. Marín-Jiménez, Automatic generation and detection of highly reliable fiducial markers under occlusion, In Pattern Recognition, Volume 47, Issue 6, 2014, Pages 2280-2292, ISSN 0031-3203 can be used to detect, identify and track unique visual patterns and appearance, and are hereby incorporated by reference for all purposes as if set forth herein in their entireties.

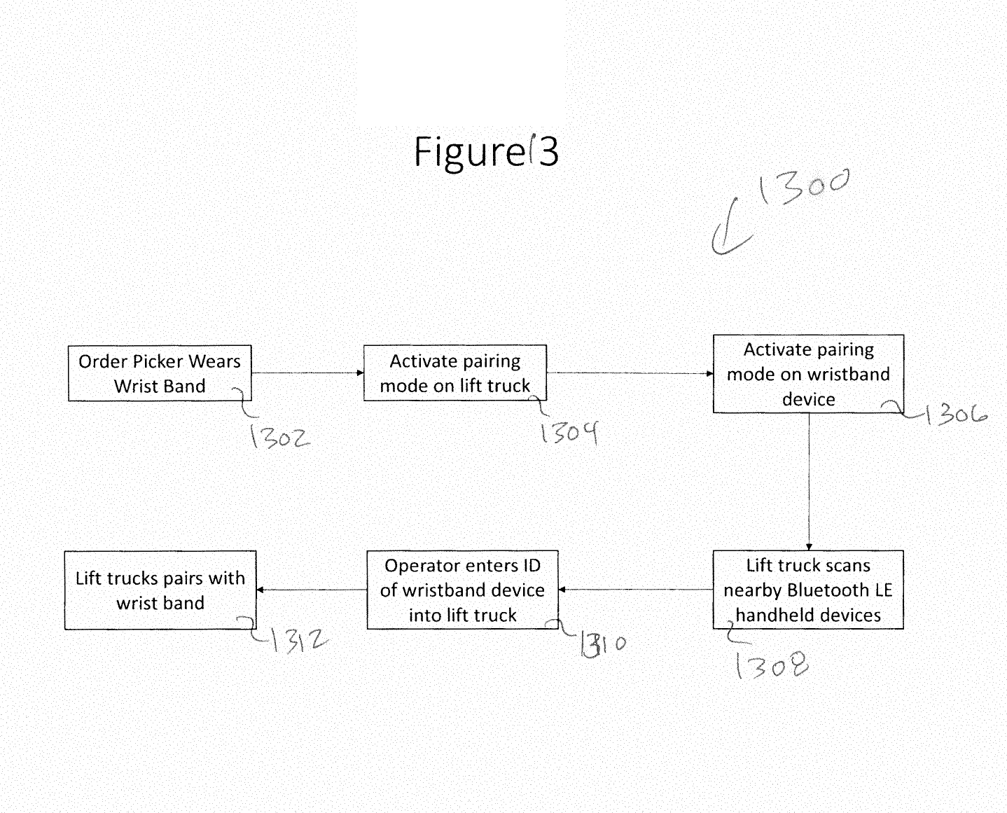

FIG. 13 is a diagram 1300 of a flow chart of an example algorithm that can be implemented in hardware and/or software for system control and operation. Algorithm 1300 can be implemented in hardware or a suitable combination of hardware and software, and can include one or more commands operating on one or more processors. While algorithm 1300 and other example algorithms disclosed herein can be shown or described in flow chart form, they can also or alternatively be implemented using state machines, object-oriented programming or in other suitable manners.

An order picker wears a wristband at 1302. Pairing mode is activated on the lift truck at 1304. Pairing mode is activated on the wristband device at 1306. The lift truck scans nearby Bluetooth LE handheld devices at 1308. The operator enters an ID of a wristband device into the lift truck at 1310. The lift truck pairs with the wrist band at 1312.

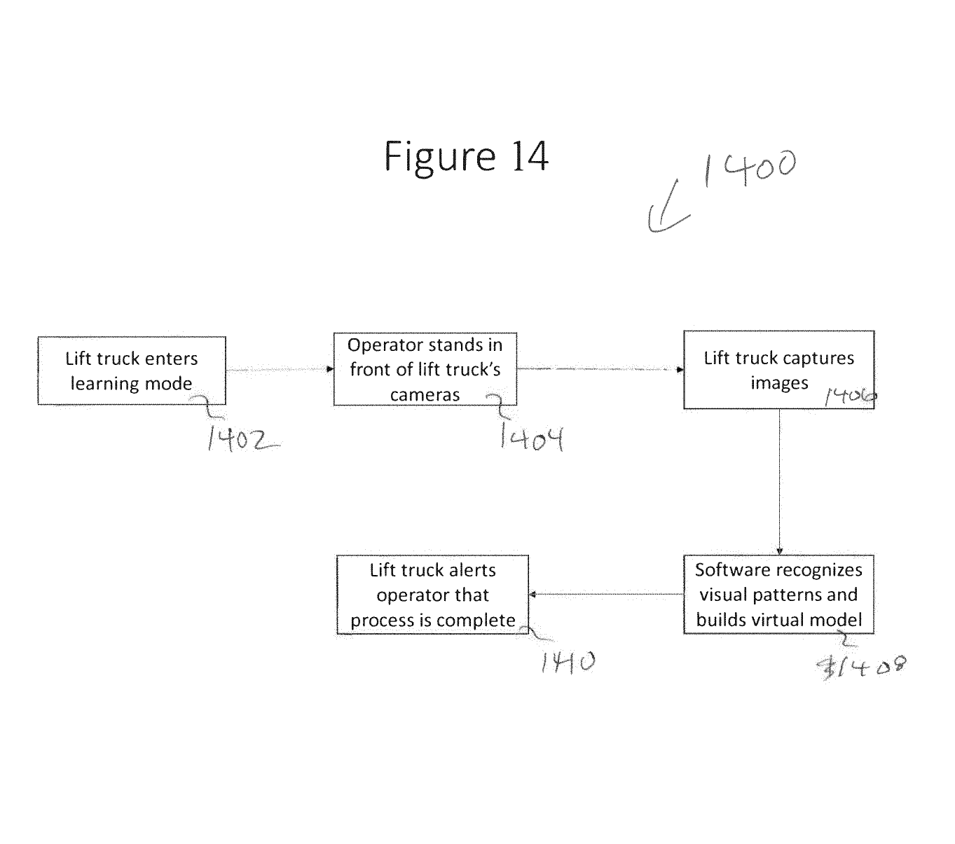

FIG. 14 is a diagram 1400 of a flow chart of an example algorithm that can be implemented in hardware and/or software for the visual training process. Algorithm 1400 can be implemented in hardware or a suitable combination of hardware and software, and can include one or more commands operating on one or more processors. While algorithm 1400 and other example algorithms disclosed herein can be shown or described in flow chart form, they can also or alternatively be implemented using state machines, object-oriented programming or in other suitable manners.

Algorithm 1400 begins at 1402 where a lift truck enters a learning mode. At 1404 the operator stands in front of the lift truck cameras. At 1406 the lift truck captures images. At 1408 the software recognizes visual patterns and builds a virtual model. At 1410 the lift truck alerts the operators that the process is complete.

In an autonomously following the order picking task, the order picker presses a follow-me button on the wristband device, which generates a suitable control that causes the controller of the lift truck to enter an operational state where it follows the operator, using image data or other suitable data. The operator can also or alternatively speak coded voice commands into the wrist band device such as “lift truck follow” to activate the leader-follower behavior in the lift truck. The operator carries out the order picking process and walks through the facility. The controller of the lift truck uses its imaging sensors and associated computer vision software to track visual patterns of the order pickers appearance based on a model it has learned.

The controller of the lift truck estimates the position of the order picker relative to itself. Then using data defining its own position from a location and mapping system (e.g. GPS or other suitable systems), it utilizes the two sets of image data to estimate the position of the order picker in the warehouse.

The controller of the lift truck then uses its control system to move forward, backward or stop and always maintains a set safe distance behind the order picker.

If the controller of the lift truck detects an obstacle in the way by processing image data generated by the computer vision software enabled system as the lift truck is being operated, it creates an audio alert such as a honk and plans a new route to bypass the obstacle (such as if the obstacle is not human or in other suitable manners).

If the controller of the lift truck determines that it is not able to safely bypass the obstacle, it generates and sends an alert to the order picker via audio visual cues and haptic cues through the wristband, e.g., vibration alert or in other suitable manners.

At any time if the operator needs to override the automatic behavior, the operator can use a physical button on the wristband or other suitable controls to stop the vehicle. The order picker can also speak into the hand held device to give voice commands. Examples of such commands are: 1) “Lift truck stop”—the vehicle stops immediately; 2) “Lift truck follow”—the vehicle switches to following mode and moves forward to follow operator but stays behind the human operator at all times.

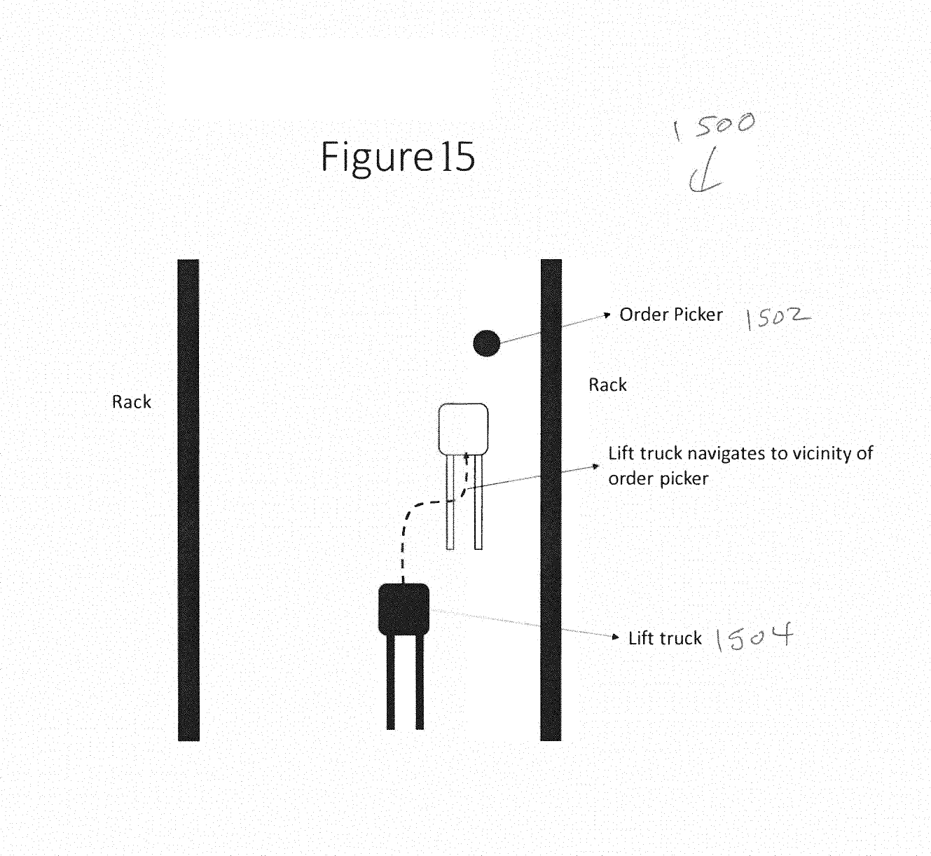

FIG. 15 is a diagram 1500 of a lift truck 1504 following an order picker 1502 and maintaining a set distance from the order picker. In one example embodiment, lift truck 1504 can include a processor operating under algorithmic control, where the algorithms are configured to receive image data of order picker 1502, either alone or in combination with a vest or other item of clothing having predetermined markings, a handheld controller or other device with a radio beacon or other suitable devices. The algorithmic controls can be configured to determine a distance from lift truck 1504 to order picker 1502, such as by using a sonar, LiDAR, radar or other suitable devices, wireless media transmission time data or other suitable data, and can execute one or more predetermined routines for maintaining a safe distance between lift truck 1504 and order picker 1502, such as by using one or more predetermined zones. The size of the zones can be adjusted based on whether the zone is used to maintain a safe distance between lift truck 1504 and order picker 1502, between lift truck 1504 and pallet racks, between lift truck 1504 and unknown obstacles and so forth.

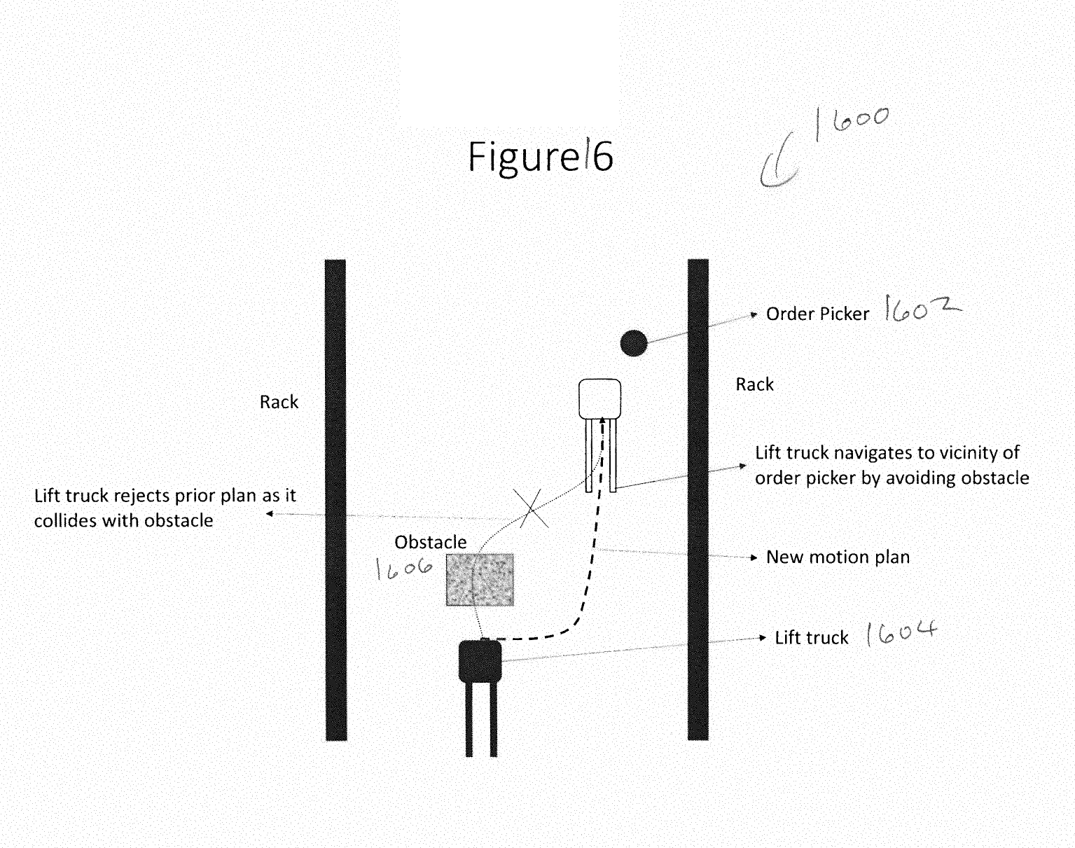

FIG. 16 is a diagram 1600 of a lift truck 1604 following an order picker 1602 and avoiding an obstacle 1606 on the way. In one example embodiment, lift truck 1604 can include a processor operating under algorithmic control, where the algorithms are configured to receive image data of order picker 1602, either alone or in combination with a vest or other item of clothing having predetermined markings, a handheld controller or other device with a radio beacon or other suitable devices. The algorithmic controls can be configured to determine a distance from lift truck 1504 to order picker 1602, such as by using a sonar, LiDAR, radar or other suitable devices, wireless media transmission time data or other suitable data, and can execute one or more predetermined routines for maintaining a safe distance between lift truck 1604 and order picker 1602, such as by using one or more predetermined zones. The size of the zones can be adjusted based on whether the zone is used to maintain a safe distance between lift truck 1604 and order picker 1602, between lift truck 1604 and pallet racks, between lift truck 1604 and unknown obstacles 1606 and so forth.

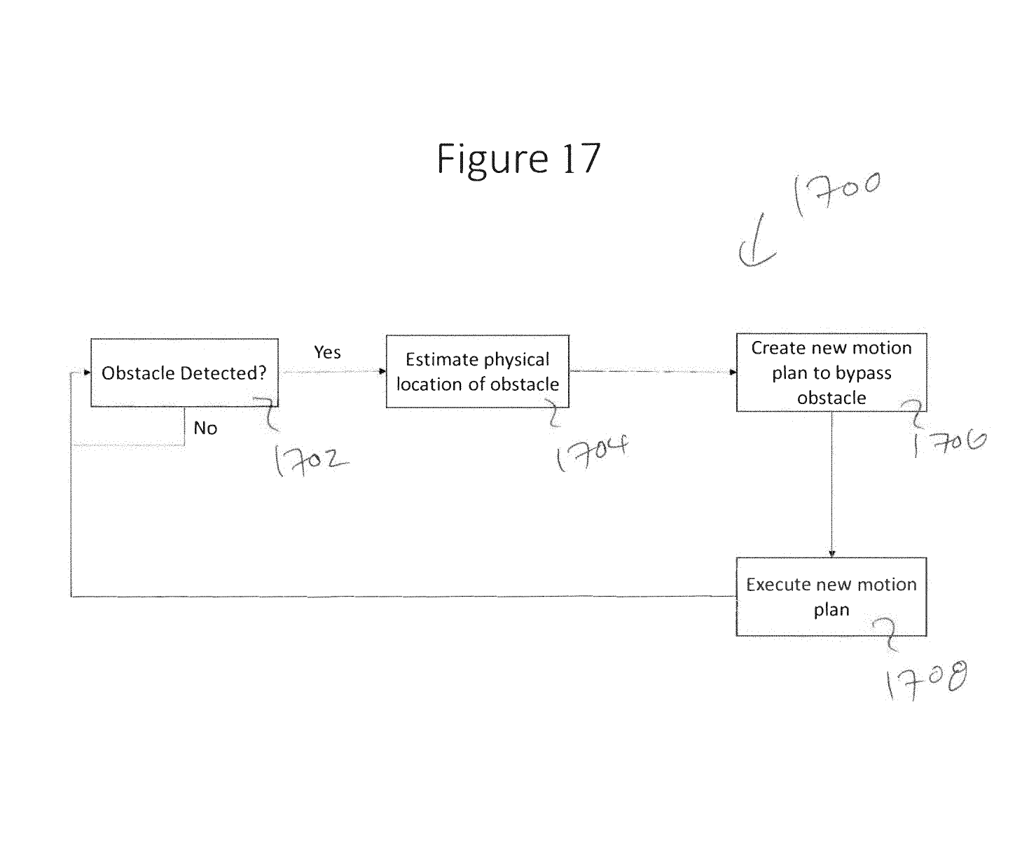

FIG. 17 is a flow chart 1700 of an example algorithm that can be implemented in hardware and/or software for the replanning process when an obstacle is detected. Algorithm 1700 can be implemented in hardware or a suitable combination of hardware and software, and can include one or more commands operating on one or more processors. While algorithm 1700 and other example algorithms disclosed herein can be shown or described in flow chart form, they can also or alternatively be implemented using state machines, object-oriented programming or in other suitable manners.

Algorithm 1700 begins at 1702, where a processor of a vehicle that is operating under algorithmic control causes direction bearing sensors, object detection sensors and other sensors such as cameras or LiDAR to generate data and processes the generated data detect environmental barriers, objects and other potential obstacles. If an obstacle is detected, the algorithm proceeds to 1704, where the algorithms determine the obstacle position with respect to the lift truck. In one example embodiment, the algorithms of the lift truck controller can use data defining a current position of the lift truck relative to a map of the facility, and evaluates whether the obstacle is a known environmental barrier or object, or if it is an unknown obstacle. The algorithm then proceeds to 1706.

At 1706, the algorithmic controls determine a course to either navigate around the environmental barrier or object (either by extracting a previously calculated course or calculating a new course if a course has not previously been calculated), or generates an operator alert of a course cannot be determined. The algorithm then proceeds to 1708, where the course is implemented, such as by controlling one or more actuators to cause the vehicle to advance, reverse, turn left, turn right, to perform a predetermined sequence of motions or to take other suitable actions. Algorithms disclosed in S. Karaman AND E. Frazzoli, Incremental Sampling-based Algorithms for Optimal Motion Planning, In Proceedings of Robotics: Science and Systems, June 2010, Zaragoza, Spain, which is hereby incorporated by reference for all purposes as if set forth herein in its entirety, can be used to plan paths in the physical dimension.

As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. As used herein, phrases such as “between X and Y” and “between about X and Y” should be interpreted to include X and Y. As used herein, phrases such as “between about X and Y” mean “between about X and about Y.” As used herein, phrases such as “from about X to Y” mean “from about X to about Y.”

As used herein, “hardware” can include a combination of discrete components, an integrated circuit, an application-specific integrated circuit, a field programmable gate array, or other suitable hardware. As used herein, “software” can include one or more objects, agents, threads, lines of code, subroutines, separate software applications, two or more lines of code or other suitable software structures operating in two or more software applications, on one or more processors (where a processor includes one or more microcomputers or other suitable data processing units, memory devices, input-output devices, displays, data input devices such as a keyboard or a mouse, peripherals such as printers and speakers, associated drivers, control cards, power sources, network devices, docking station devices, or other suitable devices operating under control of software systems in conjunction with the processor or other devices), or other suitable software structures. In one exemplary embodiment, software can include one or more lines of code or other suitable software structures operating in a general purpose software application, such as an operating system, and one or more lines of code or other suitable software structures operating in a specific purpose software application. As used herein, the term “couple” and its cognate terms, such as “couples” and “coupled,” can include a physical connection (such as a copper conductor), a virtual connection (such as through randomly assigned memory locations of a data memory device), a logical connection (such as through logical gates of a semiconducting device), other suitable connections, or a suitable combination of such connections. The term “data” can refer to a suitable structure for using, conveying or storing data, such as a data field, a data buffer, a data message having the data value and sender/receiver address data, a control message having the data value and one or more operators that cause the receiving system or component to perform a function using the data, or other suitable hardware or software components for the electronic processing of data.

In general, a software system is a system that operates on a processor to perform predetermined functions in response to predetermined data fields. For example, a system can be defined by the function it performs and the data fields that it performs the function on. As used herein, a NAME system, where NAME is typically the name of the general function that is performed by the system, refers to a software system that is configured to operate on a processor and to perform the disclosed function on the disclosed data fields. Unless a specific algorithm is disclosed, then any suitable algorithm that would be known to one of skill in the art for performing the function using the associated data fields is contemplated as falling within the scope of the disclosure. For example, a message system that generates a message that includes a sender address field, a recipient address field and a message field would encompass software operating on a processor that can obtain the sender address field, recipient address field and message field from a suitable system or device of the processor, such as a buffer device or buffer system, can assemble the sender address field, recipient address field and message field into a suitable electronic message format (such as an electronic mail message, a TCP/IP message or any other suitable message format that has a sender address field, a recipient address field and message field), and can transmit the electronic message using electronic messaging systems and devices of the processor over a communications medium, such as a network. One of ordinary skill in the art would be able to provide the specific coding for a specific application based on the foregoing disclosure, which is intended to set forth exemplary embodiments of the present disclosure, and not to provide a tutorial for someone having less than ordinary skill in the art, such as someone who is unfamiliar with programming or processors in a suitable programming language. A specific algorithm for performing a function can be provided in a flow chart form or in other suitable formats, where the data fields and associated functions can be set forth in an exemplary order of operations, where the order can be rearranged as suitable and is not intended to be limiting unless explicitly stated to be limiting.

It should be emphasized that the above-described embodiments are merely examples of possible implementations. Many variations and modifications may be made to the above-described embodiments without departing from the principles of the present disclosure. All such modifications and variations are intended to be included herein within the scope of this disclosure and protected by the following claims.

What is claimed is:

1. A method to retrofit industrial lift trucks for automated material handling, comprising:
configuring a processor to associate a plurality of sensors with a plurality of locations of a vehicle;
implementing a mapping mode of the processor to cause the plurality of sensors to generate sensor data as the vehicle is moved around a facility;
generating a map of the facility from the sensor data; and
receiving an operator input to define a mission, wherein the operator input comprises one of an object pick up command and an object drop off command.

2. The method of claim 1, wherein configuring the processor to associate the plurality of sensors with the plurality of locations of the vehicle further comprises configuring the processor to associate one or more actuators with a vehicle control.

3. The method of claim 1, wherein configuring the processor to associate the plurality of sensors with the plurality of locations of the vehicle further comprises configuring the processor to associate a range sensor with a front of the vehicle.

4. The method of claim 1, wherein configuring the processor to associate the plurality of sensors with the plurality of locations of the vehicle further comprises configuring the processor to associate an image sensor with a front of the vehicle.

5. The method of claim 1, wherein configuring the processor to associate the plurality of sensors with the plurality of locations of the vehicle further comprises configuring the processor to associate a unique remote control with a remote control interface.

6. The method of claim 1, wherein configuring the processor to associate the plurality of sensors with the plurality of locations of the vehicle further comprises configuring the processor to associate a unique set of image data with a remote control interface.

7. The method of claim 6, further comprising configuring the processor to generate an actuator control signal to cause the vehicle to follow the unique set of image data as it moves.

8. The method of claim 6, further comprising configuring the processor to generate a first actuator control signal to cause the vehicle to accelerate in a direction of the unique set of image data when it starts moving and a second actuator control signal to cause the vehicle to apply a braking force when the unique set of image data stops moving.

9. The method of claim 6, further comprising configuring the processor to generate a first actuator control signal to cause the vehicle to accelerate in a direction of the unique set of image data when it starts moving, a second actuator signal to cause the vehicle to change direction to follow the unique set of image data as it moves and a third actuator control signal to cause the vehicle to apply a braking force when the unique set of image data stops moving.

10. A system to retrofit industrial lift trucks for automated material handling, comprising:
a plurality of sensors configured to be disposed at two or more user-selectable locations of a vehicle;
a processor configured to associate each of the plurality of sensors with one of the locations of the vehicle;
the processor configured to implement a mapping mode to cause the plurality of sensors to generate sensor data as the vehicle is moved around a facility;
the processor configured to generate a map of the facility from the sensor data; and
the processor configured to receive an operator input to define a mission, wherein the operator input comprises one of an object pick up command and an object drop off command.

11. The system of claim 10, wherein the processor is configured to associate one or more actuators with a vehicle control.

12. The system of claim 10, wherein the processor is configured to associate a range sensor with a front of the vehicle.

13. The system of claim 10, wherein the processor is configured to associate an image sensor with a front of the vehicle.

14. The system of claim 10, wherein the processor is configured to associate a unique remote control with a remote control interface.

15. The system of claim 10, wherein the processor is configured to associate a unique set of image data with a remote control interface.

16. The system of claim 15, wherein the processor is configured to generate an actuator control signal to cause the vehicle to follow the unique set of image data as it moves.

17. The system of claim 15, wherein the processor is configured to generate a first actuator control signal to cause the vehicle to accelerate in a direction of the unique set of image data when it starts moving and a second actuator control signal to cause the vehicle to apply a braking force when the unique set of image data stops moving.

18. The system of claim 15, wherein the processor is configured to generate a first actuator control signal to cause the vehicle to accelerate in a direction of the unique set of image data when it starts moving, a second actuator signal to cause the vehicle to change direction to follow the unique set of image data as it moves and a third actuator control signal to cause the vehicle to apply a braking force when the unique set of image data stops moving.

19. A method to retrofit industrial lift trucks for automated material handling, comprising:
configuring a processor to associate a plurality of sensors and at least one actuator with a plurality of locations of a vehicle;
implementing a mapping mode of the processor to cause the plurality of sensors to generate sensor data as the vehicle is moved around a facility;
generating a map of the facility from the sensor data; and
receiving an operator input to define a mission, wherein the operator input comprises an operator identification command to associate unique identifying data with the operator and wherein the processor is configured to generate actuator control signals in response to detection of the unique identifying data in the sensor data.

20. The method of claim 19 wherein the processor is configured to generate the actuator control signals to maintain a predetermined distance between the vehicle and the operator.
